(19) United States
(12) Patent Application Publication
(10) Pub. No.: US 2009/0031984 A1
(43) Pub. Date: Feb. 5, 2009

(54) NON-EQUILIBRIUM PLASMA DISCHARGE TYPE IGNITION DEVICE

(75) Inventors: Taisuke SHIRAISHI, Yokohama-shi (JP); Eiji Takahashi, Yokosuka-shi (JP); Tomonori Urushihara, Yokohama-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 12/177,497

(22) Filed: Jul. 22, 2008

(30) Foreign Application Priority Data
Aug. 2, 2007 (JP) 2007-201960

(51) Int. Cl. F02B 19/12; F02P 15/00; F02P 3/01

(52) U.S. Cl. 123/260; 123/266; 123/283; 123/634; 123/647

(57) ABSTRACT

An ignition device which performs a spark ignition of a fuel mixture in a combustion chamber (13) of an internal combustion engine (100), comprising, a first electrode (51), a second electrode (52) which is opposed to the first electrode (51) and extends in a length allowing generation of a plurality of non-equilibrium plasma discharges, and a voltage impressing device (60, 70) which impresses voltage between the first electrode (51) and the second electrode (52) to generate the non-equilibrium plasma discharge between the first electrode (51) and the second electrode (52). With this construction, volumetric ignition is effected on the fuel mixture, and hence ignition performance for the fuel mixture is improved, making it possible to substantially expand a lean burn limit.

### FIELD OF THE INVENTION

This invention relates to an ignition device which ignites a fuel mixture to be combusted by an internal combustion engine by non-equilibrium plasma discharge.

### BACKGROUND OF THE INVENTION

JPH 03-031579A published by the Japan Patent Office in 1991 proposes an ignition device which ignites a fuel mixture in a combustion chamber of an internal combustion engine through application of the non-equilibrium plasma discharge. The non-equilibrium plasma discharge is also called low-temperature plasma discharge or corona discharge.

The ignition device according to the prior art comprises a pair of electrodes whose forward ends are pointed and which is arranged within a microwave waveguide whose one end is open to the combustion chamber. In this ignition device, when a piston reaches a predetermined position, a microwave pulse is transmitted to the microwave waveguide, whereby the non-equilibrium plasma discharge occurs between the electrodes, thereby igniting a fuel mixture within the combustion chamber.

### SUMMARY OF THE INVENTION

In the ignition device according to the prior art, the non-equilibrium plasma discharge is effected between the forward ends of a pair of the electrodes to ignite the fuel mixture. Thus, the heat generation amount per unit volume at the time of ignition is small, and deterioration in ignition performance is inevitable, for example, when the fuel mixture concentration is low throughout the entire combustion chamber as in the case of lean burn, or when a large amount of exhaust gas recirculation (EGR gas) is introduced to increase the EGR rate, namely, the ratio of the EGR gas amount to the fresh air amount. When the ignition performance deteriorates, chain heat generation in the periphery is impossible, and flame-out is likely to occur, and hence it is impossible to expand the lean burn limit.

It is therefore an object of this invention to realize an improvement in terms of ignition performance, and to expand the lean burn limit of an internal combustion engine.

In order to achieve the above object, this invention provides an ignition device which performs a spark ignition of a fuel mixture in a combustion chamber of an internal combustion engine. The device comprises a first electrode, a second electrode which is opposed to the first electrode and extends in a length allowing generation of a plurality of non-equilibrium plasma discharges, and a voltage impressing device which impresses voltage between the first electrode and the second electrode to generate the non-equilibrium plasma discharge between the first electrode and the second electrode.

The details as well as other features and advantages of this invention are set forth in the remainder of the specification and are shown in the accompanying drawings.

### BRIEF DESCRIPTION OF THE DRAWINGS

FIG. 1 is a schematic view of a non-equilibrium plasma discharge type internal combustion engine, illustrating the construction of an ignition device according to this invention.

FIGS. 2A and 2B are a side view, partly in longitudinal section, and a cross sectional view of a spark plug according to this invention.

FIG. 3 is a diagram illustrating the discharge condition for the non-equilibrium plasma discharge in a spark plug.

FIGS. 4A-4D are diagrams illustrating a discharged energy map stored in a controller according to this invention.

FIG. 5 is a perspective view of a variable valve mechanism provided in the internal combustion engine to which an ignition device according to a second embodiment of this invention is applied.

FIG. 6 is a diagram illustrating changes in the valve lift of an intake valve according to the variable valve mechanism.

FIG. 7 is a diagram illustrating a discharged energy map stored in a controller according to the second embodiment of this invention.

FIGS. 8A-8C are diagrams illustrating an excess air factor, an EGR rate, and an intake valve close (IVC) timing in an operation range of high-engine-rotation-speed/high-engine-load in the internal combustion engine equipped with the ignition device according to the second embodiment of this invention.

FIGS. 9A-9C are diagrams illustrating the excess air factor, the EGR rate, and the IVC timing in an operation range of low-engine-rotation-speed/low-engine-load in the internal combustion engine equipped with the ignition device according to the second embodiment of this invention.

FIG. 10 is a timing chart illustrating radical generation discharge executed by the ignition device according to the second embodiment of this invention.

FIG. 11 is a diagram illustrating the amount of radical generated through radical generation discharge executed by the ignition device of the second embodiment of this invention.

FIG. 12 is a schematic view of a non-equilibrium plasma discharge type internal combustion engine, illustrating the construction of an ignition device according to a third embodiment of this invention.

FIGS. 13A and 13B are a side view, partly in longitudinal section, and a cross sectional view of a spark plug according to the third embodiment of this invention.

FIGS. 14A-14D are diagrams illustrating a method of increasing discharged energy of the non-equilibrium plasma discharge.

FIG. 15 is a diagram illustrating a discharged energy map stored in a controller according to the third embodiment of this invention.

FIGS. 16A-16C are diagrams illustrating the excess air factor, the EGR rate, and the IVC timing in an operation range of high-engine-rotation-speed/high-engine-load in the internal combustion engine equipped with the ignition device according to the third embodiment of this invention.

FIGS. 17A-17C are diagrams illustrating the excess air factor, the EGR rate, and the IVC timing in an operation range of low-engine-rotation-speed/low-engine-load in the internal combustion engine equipped with the ignition device according to the third embodiment of this invention.

FIG. 18 is a timing chart illustrating radical generation discharge executed by the ignition device according to the third embodiment of this invention.

FIG. 19 is a schematic view of a non-equilibrium plasma discharge type internal combustion engine, illustrating the construction of an ignition device according to a fourth embodiment of this invention.

FIGS. 20A and 20B are a side view, partly in longitudinal section, and a cross sectional view of a spark plug according to the fourth embodiment of this invention.

FIG. 21 is a diagram illustrating a gap between a projection of a center electrode and an inner peripheral wall of a cylindrical electrode of the spark plug according to the fourth embodiment of this invention.

FIGS. 22A and 22B are a side view, partly in longitudinal section, and a cross sectional view of a spark plug according to a fifth embodiment of this invention.

FIG. 23 is a cross sectional view of a spark plug according to a sixth embodiment of this invention.

### DESCRIPTION OF THE PREFERRED EMBODIMENTS

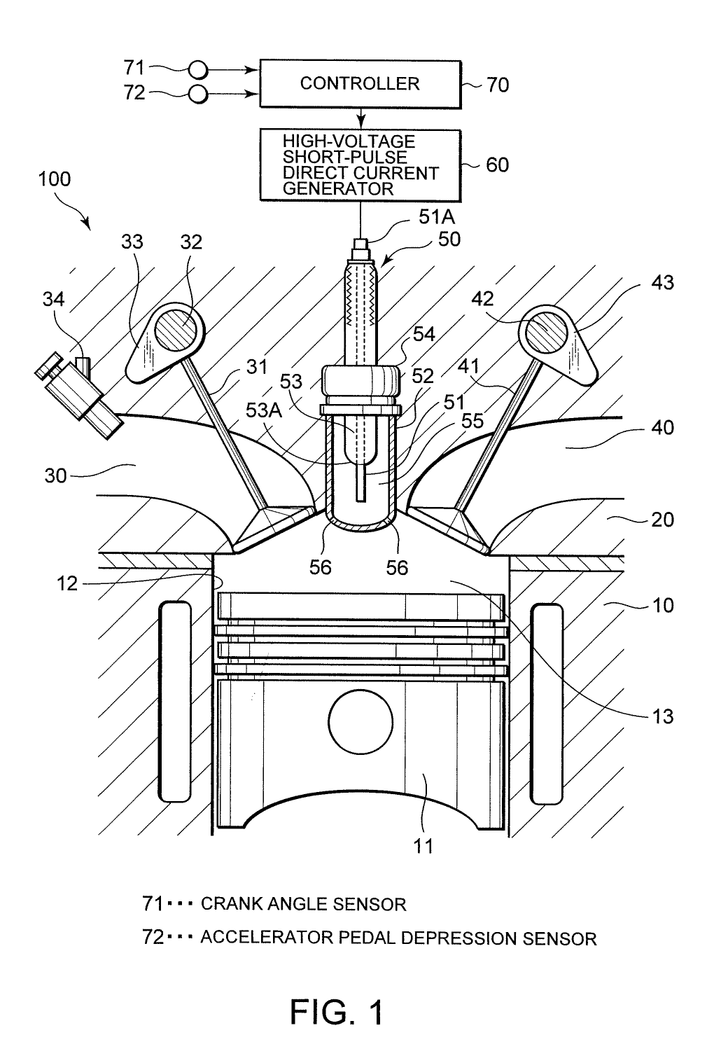

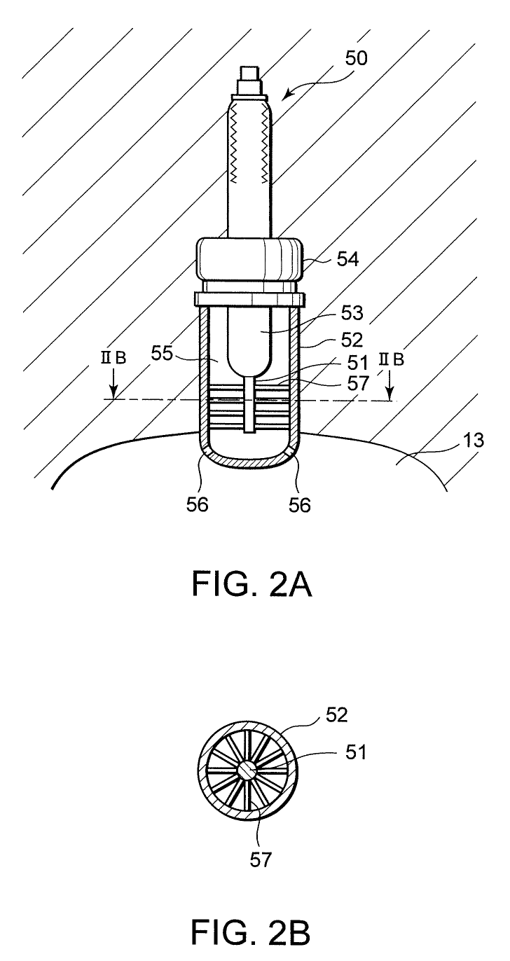

A first embodiment of this invention will be described with reference to FIG. 1, FIGS. 2A and 2B, FIG. 3, and FIGS. 4A-4D.

Referring to FIG. 1, a non-equilibrium plasma discharge type vehicle internal combustion engine 100 for a vehicle comprises a cylinder block 10, and a cylinder head 20 provided on the upper side of the cylinder block 10. The internal combustion engine 100 is a four-stroke-cycle multi-cylinder engine.

A cylinder 12 is formed in the cylinder block 10 to accommodate a piston 11. A main combustion chamber 13 is formed by a crown surface of the piston 11, a wall surface of the cylinder 12, and a bottom surface of the cylinder head 20. When fuel mixture burns in the main combustion chamber 13, the piston 11 reciprocates within the cylinder 12 under a combustion pressure.

An intake port 30 for supplying fuel mixture to the main combustion chamber 13 and an exhaust port 40 for expelling exhaust gas from the main combustion chamber 13 are formed in the cylinder head 20.

The intake port 30 is equipped with an intake valve 31. The intake valve 31 is driven by a cam 33 formed integrally with an intake camshaft 32, and opens and closes the intake port 30 as the piston 11 moves up and down. A fuel injector 34 for injecting fuel is installed in the intake port 30. The fuel injector 34 injects fuel toward an opening of the intake port 30 facing the main combustion chamber 13.

The exhaust port 40 is equipped with an exhaust valve 41. The exhaust valve 41 is driven by a cam 43 formed integrally with an exhaust camshaft 42, and opens and closes the intake port 30 as the piston 11 moves up and down. An exhaust passage for discharging exhaust gas to the exterior is connected to the exhaust port 40, and an exhaust gas recirculation (EGR) device connected to the exhaust passage causes a part of the exhaust gas to be recirculated into a flow of the intake air which is aspirated into the main combustion chamber 13 through the intake port 30.

A spark plug 50, effecting ignition on fuel mixture through the non-equilibrium plasma discharge, is installed between the intake port 30 and the exhaust port 40 of the cylinder head 20 so as to face the main combustion chamber 13. The spark plug 50 is equipped with a center electrode 51 as a first electrode, a cylindrical electrode 52 as a second electrode, an insulating member 53, and an outer shell 54.

The spark plug 50 is accommodated in a recess formed in the cylinder head 20, and is fixed to the cylinder head 20 via the outer shell 54 provided at the center in the axial direction. The spark plug 50 has an auxiliary combustion chamber 55 as an ignition chamber separated from the main combustion chamber 13 by the cylindrical electrode 52.

The cylindrical electrode 52 is formed of a conductive material, and protrudes downwards from the outer shell 54. The cylindrical electrode 52 has a plurality of communicating holes 56 at forward end thereof. The auxiliary combustion chamber 55 communicates with the main combustion chamber 13 via the communicating holes 56.

The insulating member 53 extends vertically through the outer shell 54 to protrude into the cylindrical electrode 52.

The center electrode 51 is formed of a bar-like conductor, and extends axially through the insulating member 53. The center electrode 51 protrudes from the forward end 53A of the insulating member 53 into the cylindrical electrode 52, in other words, so as to protrude into the auxiliary combustion chamber 55. The cylindrical electrode 52 is installed so as to surround the center electrode 51 protruding from the insulating member 53, and hence it is opposed to the side face of the center electrode 51. The auxiliary combustion chamber 55 is formed between the center electrode 51 and the cylindrical electrode 52 in the form of an annular gap.

The cylinder head 20 is formed of a conductive material, and is connected to the ground. The cylindrical electrode 52 is connected to the ground via the cylinder head 20.

A terminal 51A is mounted to the upper end of the center electrode 51. A high-voltage/short-pulse direct current generator 60 is connected to the terminal 51A. The high-voltage/short-pulse direct current generator 60 impresses an direct current according to the engine operation state between the terminal 51A and the ground.

The high-voltage/short-pulse direct current generator 60 is controlled by a controller 70. The controller 70 is constituted by a microcomputer comprising a central processing unit (CPU), a read-only memory (ROM), a random access memory (RAM), and an input/output interface (I/O interface). The controller 70 may be constituted by a plurality of microcomputers.

Detection data from a crank angle sensor 71 for producing a crank angle signal for each predetermined crank angle of the internal combustion engine 100, and an accelerator pedal depression sensor 72 for detecting the operating amount of an accelerator pedal provided in the vehicle are input into the controller 70 as signals.

The crank angle signal is used as a signal representative of an engine rotation speed of the internal combustion engine 100. The operating amount of the accelerator pedal is used as a signal representative of the engine load of the internal combustion engine 100.

Based on these input signals, the controller 70 controls a voltage value, an impression time period (pulse width), and the impression timing of the high-voltage/short-pulse direct current generator 60 to control the ignition timing of the spark plug 50 and the discharged energy of the non-equilibrium plasma discharge.

In the internal combustion engine 100, the fuel injector 34 injects fuel into the intake port 30. When the piston 11 moves downwards, the pressure in the main combustion chamber 13 becomes lower than the pressure in the intake port 30. When the intake valve 31 is opened in this state, fuel mixture flows from the intake port 30 into the main combustion chamber 13 due to the difference in pressure between the intake port 30 and the main combustion chamber 13.

After the intake valve 31 is closed, the fuel mixture is compressed due to the rise of the piston 11, and a portion of the fuel mixture flows into the auxiliary combustion chamber 55 via the communicating holes 56. Immediately before the piston 11 reaches the compression top dead center, the fuel mixture which has flowed into the auxiliary combustion chamber 55 is ignited through the non-equilibrium plasma discharge of the spark plug 50. In this way, a flame is generated in the auxiliary combustion chamber 55, and is radiated in a torch-like fashion through the communicating holes 56, burning the fuel mixture in the main combustion chamber 13.

Next, the non-equilibrium plasma discharge of the spark plug 50 will be described.

Referring to FIGS. 2A and 2B, when a high voltage of short pulse width is impressed to the spark plug 50 by the high-voltage/short-pulse direct current generator 60, the spark plug 50 effects a transitional non-equilibrium plasma discharge between the center electrode 51 and the cylindrical electrode 52 preceding the equilibrium plasma discharge. As a result, a number of streamers 57 are generated in both the axial direction and the radial direction.

By forming a number of streamers 57 in the auxiliary combustion chamber 55, the spark plug 50 increases the electron temperature of the auxiliary combustion chamber 55 to thereby enhance the molecular activity thereof. As a result, there is realized simultaneous ignition at a number of points in a large ignition space. This type of ignition will be referred to as volumetric ignition.

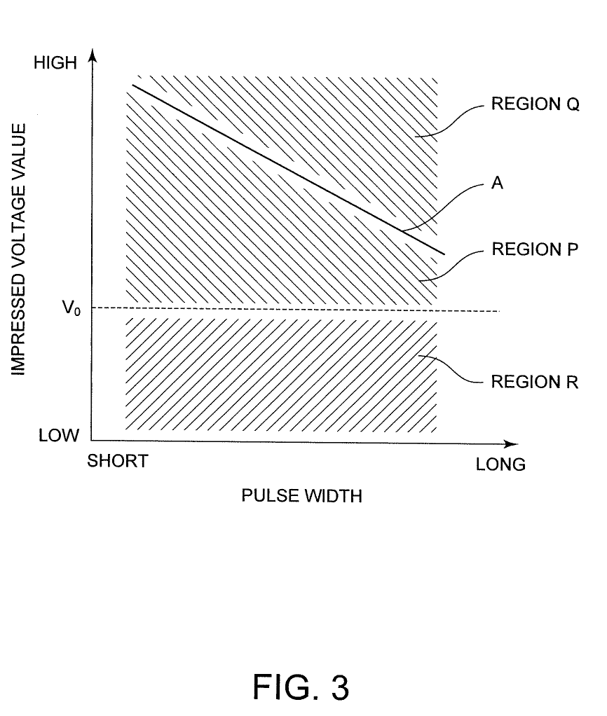

A condition under which the non-equilibrium plasma discharge is effected by the spark plug 50 will be described with reference to FIG. 3. FIG. 3 is a diagram illustrating an example of the relationship between the pulse width and the impressed voltage value.

Referring to FIG. 3, when the impressed voltage value to the spark plug 50 exceeds a boundary line A, the discharged energy increases, and transition is effected from a region P where non-plasma discharge is effected to a region Q where equilibrium plasma discharge is effected. When the discharge mode is changed to equilibrium plasma discharge, a large quantity of electric current flows through a portion bridged by the equilibrium plasma discharge, and hence the power consumption increases. The equilibrium plasma discharge is also called high-temperature plasma discharge or arc discharge.

In a region R, where the voltage value between the center electrode 51 and the cylindrical electrode 52 becomes smaller than a predetermined value V₀, the generated amount of streamers 57 is small or a dark current state is attained in which streamers 57 themselves are not generated, resulting deterioration in ignition performance.

The spark plug 50 generates a plurality of streamers 57 so as to attain suppression of the power consumption as well as an improvement in ignition performance by applying the non-equilibrium plasma discharge. In order to generate a plurality of streamers 57, the pulse width and the impressed voltage value are combined within the region P. For example, a high voltage of a short pulse width of approximately several tens to several hundred nano-second is impressed to the spark plug 50. Insofar as no transition to equilibrium plasma discharge occurs, the ignition performance is improved as the impressed voltage value increases. When it is necessary to enhance the ignition performance, it is desirable to set the pulse width short and the voltage value high so as to increase the discharged energy of the non-equilibrium plasma discharge.

The boundary line A and the predetermined value V₀ vary according to the relative density of air to the fuel in the auxiliary combustion chamber 55, and are shifted to the high voltage side when the relative density increases.

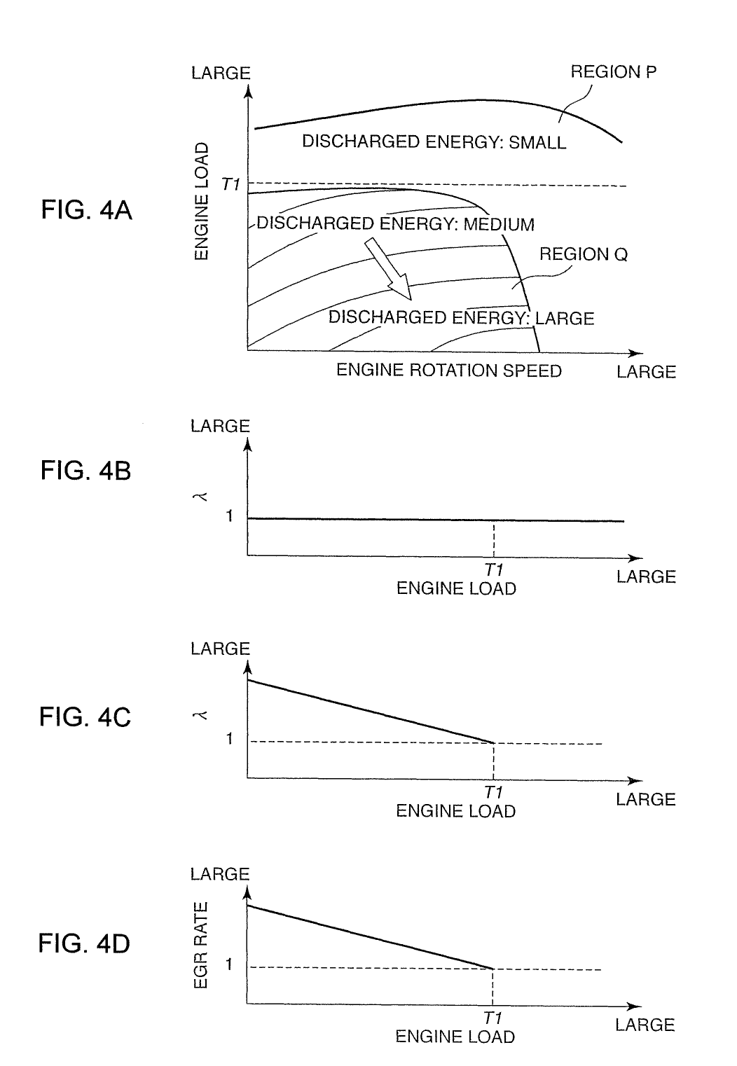

The internal combustion engine 100 equipped with the spark plug 50 is operated based on the operation maps of which the contents are shown in FIGS. 4A-4D.

Referring to FIG. 4A, the operation range for the internal combustion engine 100 is divided into a region P of high-rotation-speed/high-load and a region Q of low-rotation-speed/low-load.

Referring to FIG. 4B, during the operation in the region P, the internal combustion engine 100 is controlled such that the excess air factor λ is equal to 1, or in other wards the fuel injection amount or the intake air volume of the internal combustion engine 100 is controlled such that the air-fuel ratio of the fuel mixture becomes equal to the stoichiometric air-fuel ratio.

In the region P, the controller 70 controls the high-voltage/ short-pulse direct current generator 60 such that the discharged energy of the non-equilibrium plasma discharge of the spark plug 50 is at a fixed level irrespective of the engine operation state. In the region P, the excess air factor λ is controlled to be equal to 1 such that the fuel mixture in the auxiliary combustion chamber 55 has a composition which is easy to ignite. Thus, the discharged energy is set smaller than that during the operation in the region Q described below. However, it is possible to control the voltage value, etc. of the impressed voltage such that the discharged energy in the non-equilibrium plasma discharge increases as the rotation speed of the internal combustion engine 100 becomes higher or the engine load of the same becomes smaller within the region P.

Referring to FIG. 4C, during the operation in the region Q, the internal combustion engine 100 performs lean combustion while varying the excess air factor λ according to the engine load. Specifically, when the engine load is smaller than a predetermined value T₁, the fuel injection amount or the intake air volume is controlled such that the excess air factor λ increases as the engine load decreases. As shown in FIG. 4A, the predetermined value T₁ is determined from a maximum load in the region Q. In the lean combustion in the region Q, the ignition performance deteriorates if the same volumetric ignition is effected with the same discharged energy as in the region P.

Thus, in the region Q, the controller 70 sets the discharged energy of the non-equilibrium plasma discharge of the spark plug 50 greater than that in the region P. The controller 70 controls the voltage value, etc. of the impressed voltage in the region Q to increase the discharged energy as the engine load becomes smaller, in other words, the excess air factor λ becomes leaner. Further, the controller 70 controls the voltage value, etc. of the impressed voltage in the region Q to increase the discharged energy as the engine rotation speed becomes higher. Through this control, the ignition performance is stabilized.

While the internal combustion engine 100 performs lean combustion during the operation under low-rotation-speed/low-load corresponding to the region Q, it is also possible to perform diluted combustion by recirculating a part of the exhaust gas to the intake port 30 by the EGR device. In this case, as shown in FIG. 4D, the EGR rate is controlled to increase as the engine load becomes smaller than with respect to a predetermined value T₁. In such diluted combustion, the controller 70 controls the voltage value, etc. of the impressed voltage to increase the discharged energy as the engine load becomes smaller and the engine rotation speed becomes higher. In other words, the controller 70 controls the voltage value, etc. of the impressed voltage to increase the discharged energy as the EGR rate becomes higher.

Thus, in the ignition device for the internal combustion engine 100 according to the first embodiment, it is possible to achieve the following effects.

The spark plug 50 forms a plurality of streamers 57 between the center electrode 51 and the cylindrical electrode 52 through the non-equilibrium plasma discharge, and effects volumetric ignition on the fuel mixture in the auxiliary combustion chamber 55. Thus, even under a condition likely to lead to unstable combustion, such as lean burn or diluted combustion, it is possible to achieve a sufficiently large heat generation. As a result, the ignition performance with respect to the fuel mixture in the auxiliary combustion chamber 55 increases, and the combustion period for the fuel mixture can be shortened, making it possible to substantially expand the lean burn limit.

Since torch ignition is effected on the fuel mixture in the main combustion chamber 13 by using the combustion gas generated in the auxiliary combustion chamber 55, the combustion of the fuel mixture in the main combustion chamber 13 is further promoted. As a result, the lean burn limit can be expanded.

The spark plug 50 forms the auxiliary combustion chamber 55 by the cylindrical electrode 52, and hence it is possible to generate streamers 57 of the non-equilibrium plasma discharge in the wide-range space within the auxiliary combustion chamber 55.

In the internal combustion engine 100, in the region Q, where lean burn or diluted combustion is effected, the cylinder temperature at the ignition timing decreases, and the combustion performance is subject to fluctuation. However, since the discharged energy of the non-equilibrium plasma discharge of the spark plug 50 is set larger than that in the region P, the fluctuation in the combustion performance can be suppressed.

In the internal combustion engine 100, the voltage value, etc. of the impressed voltage are controlled such that the discharged energy of the non-equilibrium plasma discharge of the spark plug 50 increases as the engine load decreases. Thus, it is possible to suppress fluctuations in the combustion performance under a low load, in which the combustion performance is rather unstable.

Further, in the combustion engine 100, the voltage value, etc. of the impressed voltage are controlled such that the discharged energy of the spark plug 50 increases as the engine rotation speed increases. Thus, it is possible to achieve an improvement in terms of combustion speed under a high engine rotation speed, in which required time for a unit crank angle rotation is short.

Further, the voltage value, etc. of the impressed voltage are controlled such that the discharged energy of the non-equilibrium plasma discharge of the spark plug 50 increases as the air-fuel ratio becomes leaner, or as the EGR rate becomes higher. Thus, it is possible to enhance the ignition performance under an operating condition which leads to unstable combustion performance.

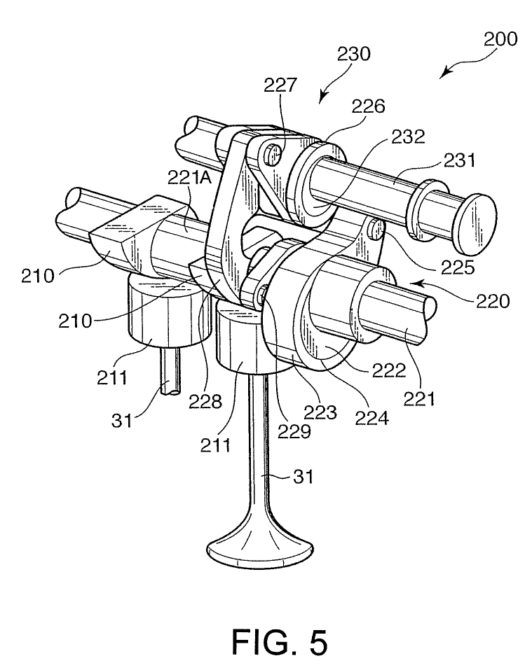

Referring to FIGS. 5-7, FIGS. 8A-8C, FIGS. 9A-9C, FIG. 10, and FIG. 11, a second embodiment of this invention will be described.

The construction of the internal combustion engine 100 according to the second embodiment is substantially the same as that of the first embodiment except that a chemical species of high reactivity (hereinafter, referred to as “radical”) is generated in the auxiliary combustion chamber 55 prior to the volumetric ignition performed by the spark plug 50. In the second embodiment, an improvement in ignition performance is achieved by the radical.

The ignition device according to this embodiment is applied to an internal combustion engine 100 equipped with a variable valve mechanism 200, which makes the valve characteristics such as the lift amount and operation angle of the intake valve 31 variable. The internal combustion engine 100 is a four-stroke-cycle multi-cylinder engine and executes Miller-cycle engine operation according to the engine operating state.

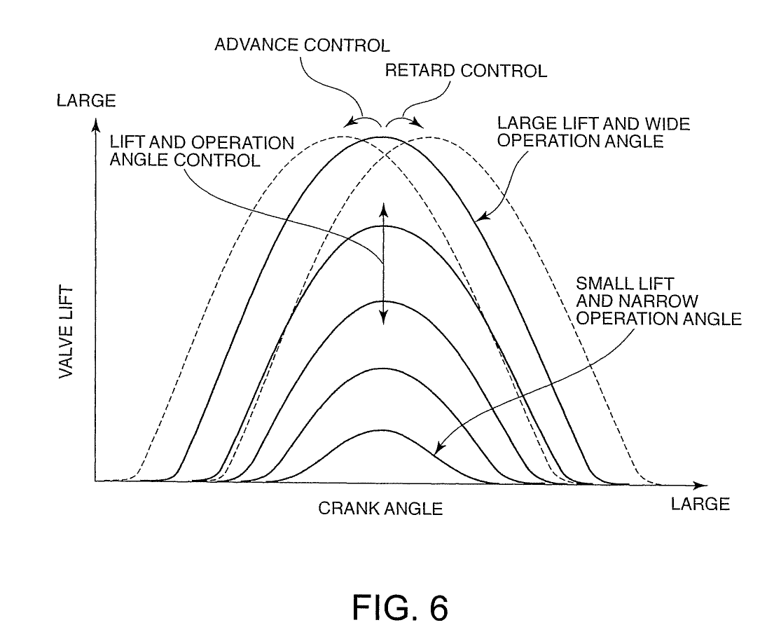

Referring to FIGS. 5 and 6, the variable valve mechanism 200 will be described.

In the non-equilibrium plasma discharge type internal combustion engine 100, each of the cylinders is equipped with two intake ports 30 and two intake valves 31. The two intake valves 31 are opened and closed in synchronism with each other by a single variable valve mechanism 200.

The variable valve mechanism 200 comprises two oscillating cams 210, an oscillating cam driving mechanism 220 for oscillating the oscillating cams 210, and a lift amount varying mechanism 230 capable of continuously changing the lift amounts of the two intake valves 31.

The oscillating cams 210 are fitted onto the outer periphery of a drive shaft 221 extending in the cylinder row direction of the internal combustion engine 100, so as to be free to rotate. The oscillating cams 210 open and close the intake valves 31 via valve lifters 211. The two oscillating cams 210 are connected in the same phase via a connecting cylinder 221A which is supported on the outer periphery of the drive shaft 221 so as to be free to rotate. The two oscillating cams 210 operate in synchronism with each other.

An eccentric cam 222 is fixed to the drive shaft 221 by press-fitting or the like. The eccentric cam 222 has a circular outer peripheral surface, and the center of its outer peripheral surface is offset from the axis of the drive shaft 221 by a predetermined amount. When the drive shaft 221 rotates together with the crankshaft, the eccentric cam 222 rotates eccentrically around the axis of the drive shaft 221. An annular section 224 at a base end of a first link 223 is fitted onto the outer peripheral surface of the eccentric cam 222 so as to be free to rotate.

A lift amount varying mechanism 230 comprises a control shaft 231 and a rocker arm 226. The rocker arm 226 is supported on the outer periphery of an eccentric cam 232 formed on the control shaft 231, so as to be free to oscillate. The rocker arm 226 has two ends extending radially.

A tip end of the first link 223 is connected to one end of the rocker arm 226 via a connecting pin 225. An upper end of a second link 228 is connected to the other end of the rocker arm 226 via a connecting pin 227. A lower end of the second link 228 is connected via a connecting pin 229 to the oscillating cams 210 for driving the intake valves 31.

When the drive shaft 221 rotates in synchronism with the engine rotation, the eccentric cam 222 makes eccentric rotation, whereby the first link 223 oscillates vertically. Through the oscillation of the first link 223, the rocker arm 226 oscillates around the axis of the eccentric cam 232, the second link 228 oscillates vertically, and the two oscillating cams 210 are oscillated within a predetermined rotation angle range via the connecting cylinder 221A. Through the synchronous oscillation of the two oscillating cams 210, the two intake valves 31 open and close the intake ports 30 synchronously.

A cam sprocket which is rotated by the crankshaft is connected to one end of the drive shaft 221. The drive shaft 221 and the cam sprocket are constructed so as to allow adjustment of the phase in their rotating direction. By changing the phase in the rotating direction of the drive shaft 221 and the cam sprocket, it is possible to adjust the phase in the rotating direction of the crankshaft and the drive shaft 221.

One end of the control shaft 231 is connected to a rotary actuator via a gear or the like. By changing the rotation angle of the control shaft 231 by the rotary actuator, the axis of the eccentric cam 232 constituting the oscillation center of the rocker arm 226 swings around the rotation center of the control shaft 231, with the result that the fulcrum of the rocker arm 226 is displaced. As a result, the attitudes of the first link 223 and the second link 228 are changed, and the distance between the oscillation center of the oscillating cams 210 and the rotation center of the rocker arm 226 changes, resulting in a change in the oscillation characteristics of the oscillating cams 210.

Referring to FIG. 6, the valve characteristics of the intake valves 31 driven by the variable valve mechanism 200, or in other words the relationship between the lift amount and the operation angle, will be described. The solid lines in the figure indicate changes in the lift amount of the intake valves 31 when the rotation angle of the control shaft 231 is varied, and the broken lines in the figure indicate changes in the lift positions of the intake valves 31 when the phase in the rotating direction of the drive shaft 221 and the cam sprocket is varied. In the variable valve mechanism 200, by changing the rotation angle of the control shaft 231 and the phase in the rotating direction of the drive shaft 221 with respect to the cam sprocket, it is possible to continuously change the valve characteristics of the intake valves 31 such as the lift amount and the operation angle thereof.

In the internal combustion engine 100, the variable valve mechanism 200 opens and closes the intake valves 31, whereby the valve characteristics are changed at the time of low-rotation-speed/low-load operation to execute Miller-cycle engine operation.

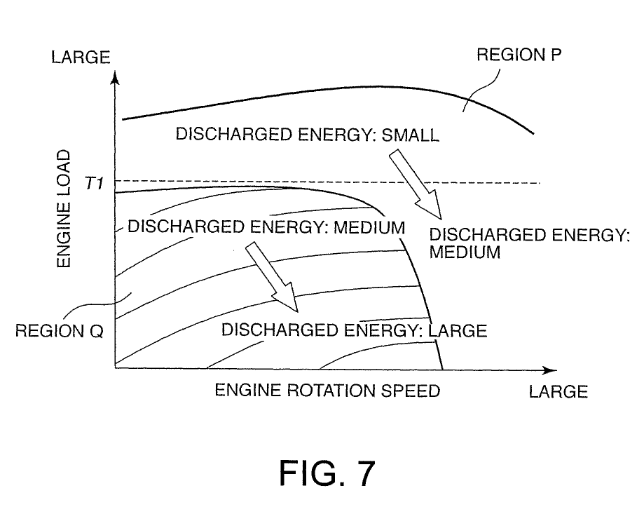

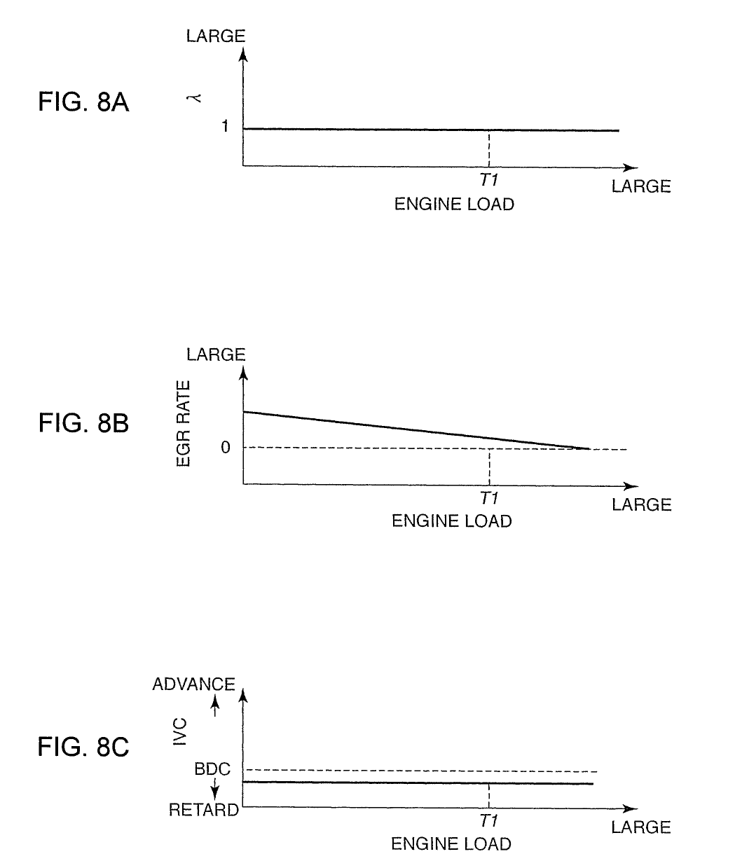

Referring to FIG. 7, FIGS. 8A-8C, FIGS. 9A-9C, FIG. 10, and FIG. 11, the operating state of the internal combustion engine 100 is described.

Referring to FIG. 7, the operation range for the internal combustion engine 100 can be divided into a region P where high-rotation-speed/high-load operation is performed and a region Q where low-rotation-speed/low-load operation is performed.

Referring to FIG. 8A, in the region P, the fuel injection amount of the internal combustion engine 100 is controlled such that the excess air factor λ is equal to 1, or in other words the air-fuel ratio is equal to the stoichiometric air-fuel ratio, irrespective of the engine operation state.

Referring to FIG. 8B, in the region P, the EGR rate is controlled according to the engine load, and the internal combustion engine 100 performs diluted combustion. The EGR rate is set to decrease as the engine load increases.

In the region P, the internal combustion engine 100 performs no Miller-cycle engine operation. Thus, as shown in FIG. 8C, the intake valve close (IVC) timing of the intake valve 31 is set so as to be retarded with respect to the piston bottom dead center.

If diluted combustion with EGR is also effected in the region P, the ignition performance for the fuel mixture deteriorates. As shown in FIG. 7, in the region P, as the engine load decreases or the engine rotation speed increases, the controller 70 adjusts the voltage value, etc. of the impressed voltage so as to increase the discharged energy in the non-equilibrium plasma discharge of the spark plug 50, thereby stabilizing the ignition performance. However, the discharged energy of the non-equilibrium plasma discharge in the region P is set smaller than that in the region Q, where low-rotation-speed/low-load operation is conducted.

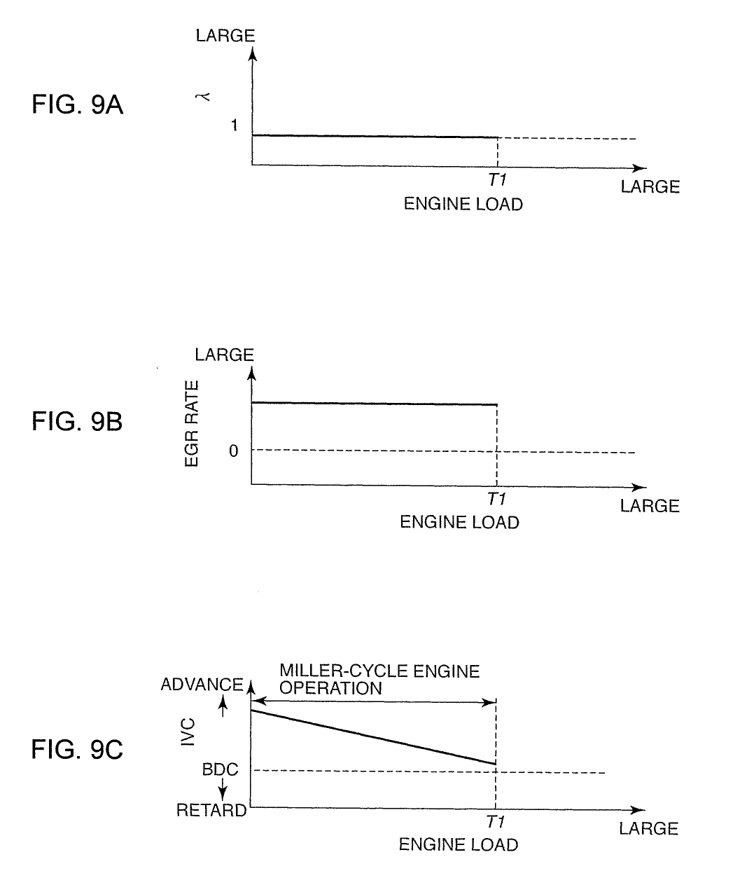

Referring to FIG. 9A, in the region Q, the fuel injection amount of the internal combustion engine 100 is controlled such that the excess air factor λ is equal to 1, or in other words the air-fuel ratio is equal to the stoichiometric air-fuel ratio, irrespective of the engine operation state,

Referring to FIG. 9B, in the region Q, the EGR rate is maintained at a fixed level, and the internal combustion engine 100 performs diluted combustion.

Referring to FIG. 9C, in the region Q, the internal combustion engine 100 performs Miller-cycle engine operation. In Miller-cycle engine operation, the IVC timing is advanced with respect to the piston bottom dead center, and the intake of fuel mixture is stopped during the intake stroke. The advancement amount of the IVC timing of the intake valves 31 is adjusted so as to become larger as the engine load decreases, causing the intake valves 31 to be closed at an early stage. Due to Miller-cycle engine operation, the pump loss is reduced even under low load, making it possible to reduce the fuel consumption.

When Miller-cycle engine operation and diluted combustion are effected in the region Q, the ignition performance for the fuel mixture deteriorates. To remedy this deterioration, the controller 70 sets the discharged energy of the non-equilibrium plasma discharge of the spark plug 50 larger than that in the region P. Further, as shown in FIG. 7, in the region Q, the controller 70 controls the voltage value, etc. of the impressed voltage such that the discharged energy of the non-equilibrium plasma discharge becomes larger as the engine load decreases, in other words the advancement amount of the IVC timing of the intake valve 31 increases. The controller 70 controls the voltage value, etc. of the impressed voltage such that the discharged energy of the non-equilibrium plasma discharge becomes larger as the engine rotation speed increases. By thus increasing the discharged energy of the spark plug 50, which effects volumetric ignition on the fuel mixture, the ignition performance of the internal combustion engine 100 is stabilized.

Further, in the internal combustion engine 100 according to the second embodiment, the radical is generated in the auxiliary combustion chamber 55, thereby achieving a further improvement in ignition performance in the region Q.

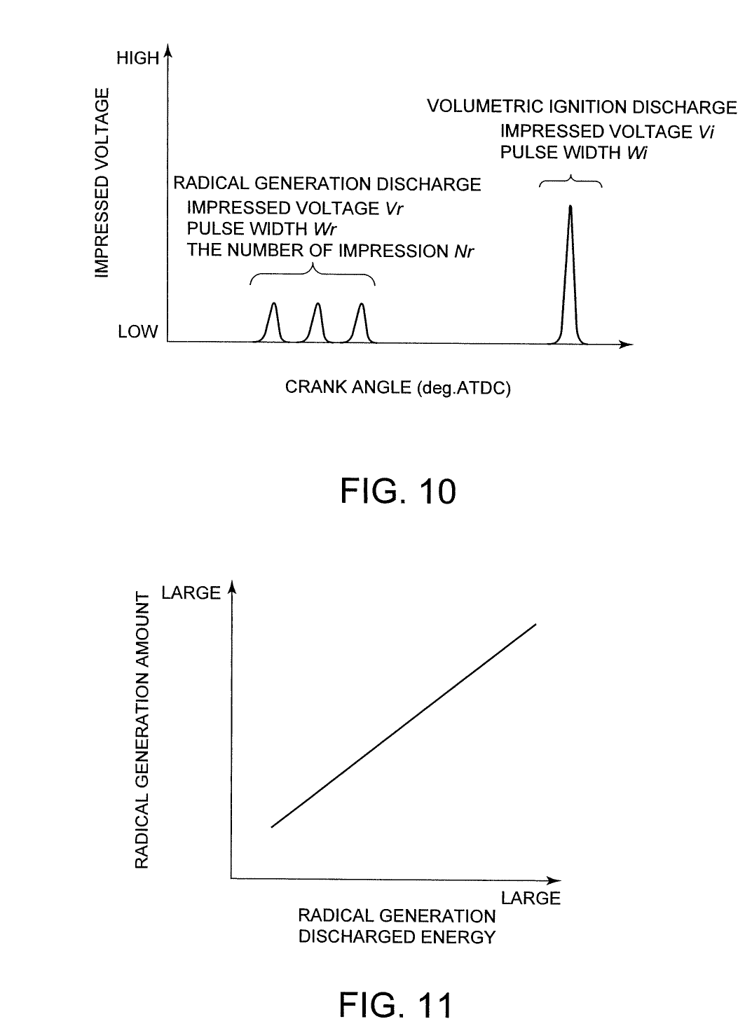

Referring to FIG. 10, the controller 70 controls the spark plug 50 such that the radical generation discharge is executed prior to volumetric ignition on the fuel mixture. The radical generation discharge is realized as the non-equilibrium plasma discharge in which the discharged energy is smaller than that at the time of volumetric ignition. The radical generated in the auxiliary combustion chamber 55 is a chemical species of high reactivity, which promotes the combustion in the auxiliary combustion chamber 55 at the time of volumetric ignition.

Referring to FIG. 11, the radical generation amount increases as the discharged energy of the non-equilibrium plasma discharge for radical generation increases. However, if the discharged energy of the non-equilibrium plasma discharge is too large, volumetric ignition is allowed to take place rather early. Thus, the controller 70 controls the voltage value, the pulse width, the number of impressions, etc. of the impressed voltage for the spark plug 50 such that the discharged energy of the discharge for radical generation is smaller than that of the discharge for volumetric ignition.

Referring again to FIG. 10, the number of impressions during the radical generation discharge is three, but this is not be limited restrictively. Thus, the number of times that voltage is impressed to the spark plug 50 is adjusted according to the requisite discharged energy for radical generation.

As described above, in the ignition device of the internal combustion engine 100 according to the second embodiment, it is possible to achieve the following effects.

The spark plug 50 of the internal combustion engine 100 executes radical generation discharge prior to volumetric ignition on the fuel mixture to generate radical in the auxiliary combustion chamber 55. As a result, the ignition performance with respect to the fuel mixture in the auxiliary combustion chamber 55 increases, and the combustion period for the fuel mixture can be shortened, making it possible to substantially expand the lean burn limit as compared with the first embodiment.

The discharged energy in the radical generation discharge is controlled to become smaller than the discharged energy in the volumetric ignition discharge. Thus, it is possible to avoid premature volumetric ignition due to the radical generation discharge.

When the internal combustion engine 100 performs Miller-cycle engine operation, the voltage value, etc. of the impressed voltage are controlled such that the discharged energy of the non-equilibrium plasma discharge becomes larger as the advancement amount of the IVC of the intake valve 31 increases. Thus, it is possible to enhance the ignition performance under an operating condition which leads to unstable combustion performance.

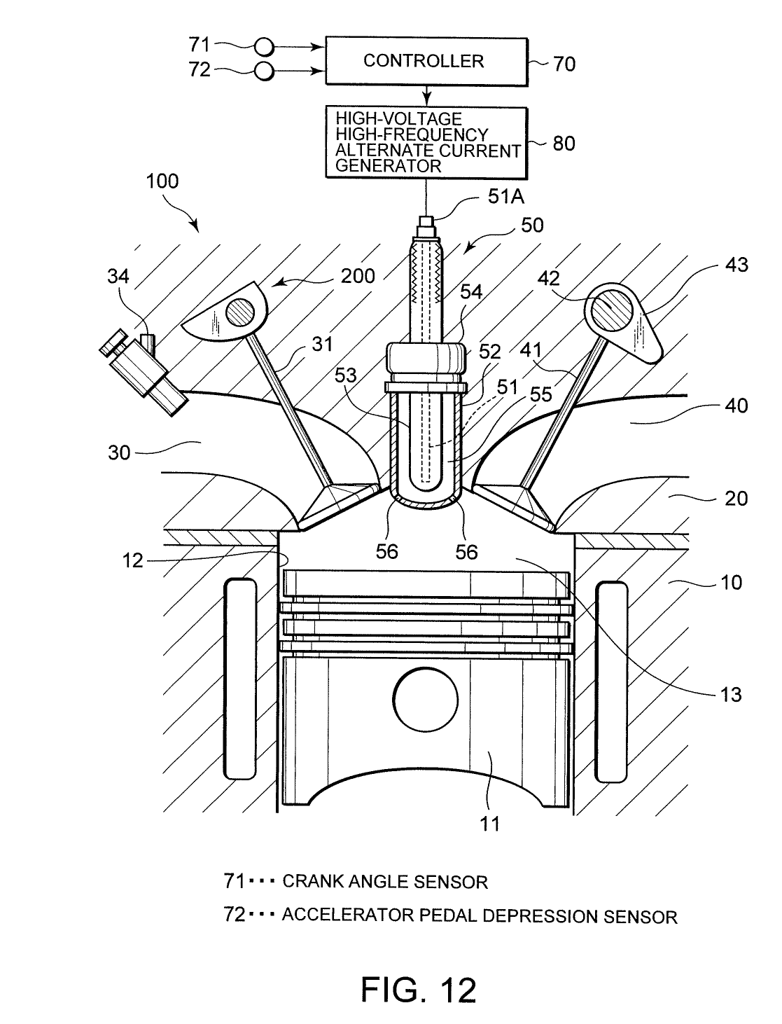

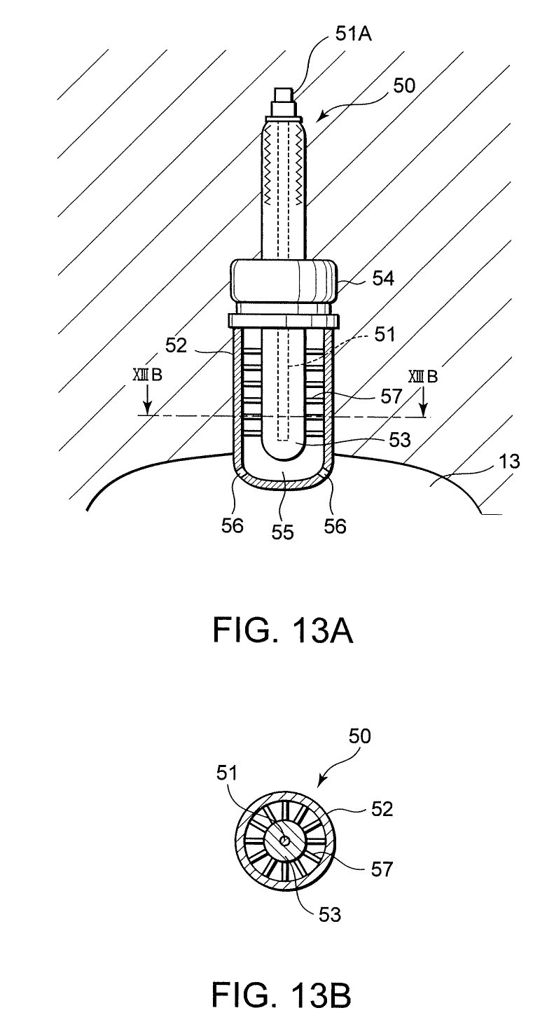

Referring to FIG. 12, FIGS. 13A and 13B, FIGS. 14A-14D, FIG. 15, FIGS. 16A-16C, FIGS. 17A-17C, and FIG. 18, a third embodiment of this invention will be described.

The internal combustion engine 100 of the third embodiment is substantially of the same construction as the second embodiment except for the construction of the spark plug 50. Specifically, the center electrode 51 of the spark plug 50 is covered with the insulating member 53.

Referring to FIG. 12, the center electrode 51 of the spark plug 50 is arranged inside the insulating member 53 formed of a dielectric material. The insulating member 53 is interposed between the center electrode 51 and the cylindrical electrode 52. A high-voltage/high-frequency alternate current generator 80 is connected to the terminal 51A of the center electrode 51. The high-voltage/high-frequency alternate current generator 80 impresses an alternating current according to the engine operation state between the terminal 51A and the ground.

The controller 70 controls a voltage value, an impression time period, a frequency, and an impression timing of the alternating current from the high-voltage/high-frequency alternate current generator 80 according to the engine operation state to control the ignition of the spark plug 50 and the discharged energy of the non-equilibrium plasma discharge.

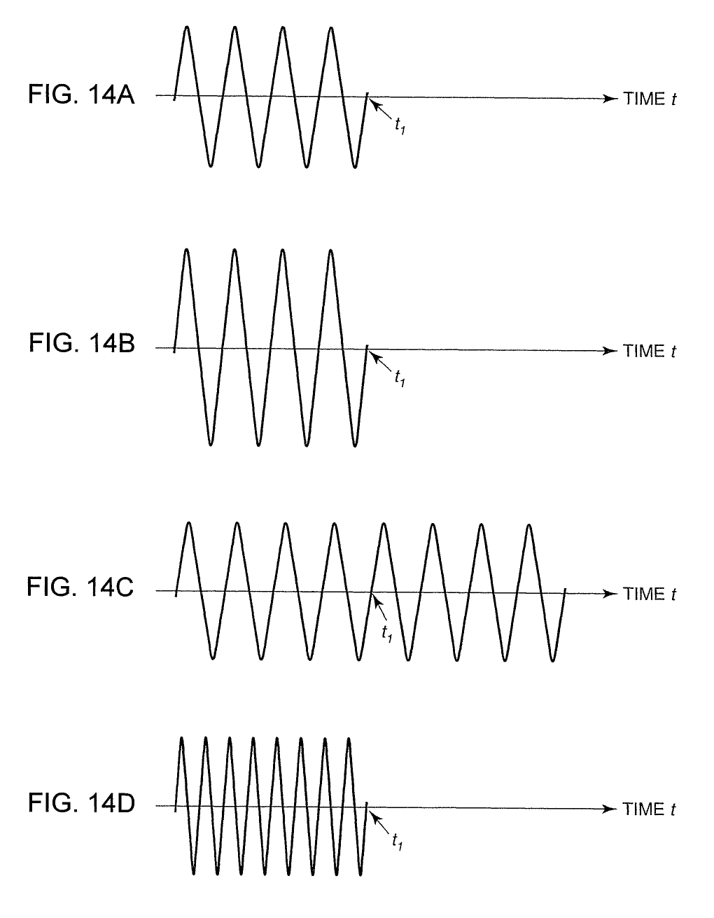

Next, the non-equilibrium plasma discharge of the spark plug 50 will be described with reference to FIG. 13A, FIG. 13B, and FIGS. 14A-14D.

Referring to FIG. 13A and FIG. 13B, when an alternating current is impressed to the spark plug 50 by the high-voltage/high-frequency alternate current generator 80, the spark plug 50 effects a transitional non-equilibrium plasma discharge, in other words dielectric barrier discharge, between the insulating member 53 and the cylindrical electrode 52 preceding the equilibrium plasma discharge. As a result, a number of streamers 57 are generated axially in the insulating member 53 as shown in FIG. 13A, and radially around the insulating member 53 as shown in FIG. 13B. By forming a number of streamers 57 in the auxiliary combustion chamber 55, the spark plug 50 increases the electron temperature of the auxiliary combustion chamber 55 to thereby enhance the molecular activity thereof. As a result, there is realized simultaneous ignition at a number of points in a large ignition space. This type of ignition will be referred to as volumetric ignition.

In the spark plug 50, the center electrode 51 is formed within the insulating member 53 formed from dielectric substance. It is therefore possible to suppress transition of the discharge between the insulating member 53 and the cylindrical electrode 52 from the non-equilibrium plasma discharge to the equilibrium plasma discharge even when the discharged energy of the center electrode 51 increases.

Referring to FIGS. 14A-14D, the discharged energy of the non-equilibrium plasma discharge generated at the spark plug 50 varies according to the voltage value, the impression time period, and the frequency of the alternating current from the high-voltage/high-frequency alternate current generator 80. With respect to a reference waveform of the alternating current shown in FIG. 14A, an increase in voltage value of the alternating current as shown in FIG. 14B, an increase in impression time period of the alternating current as shown in FIG. 14C, or an increase in the frequency of the alternating current as shown in FIG. 14D, leads to an increase in the discharged energy of the spark plug 50.

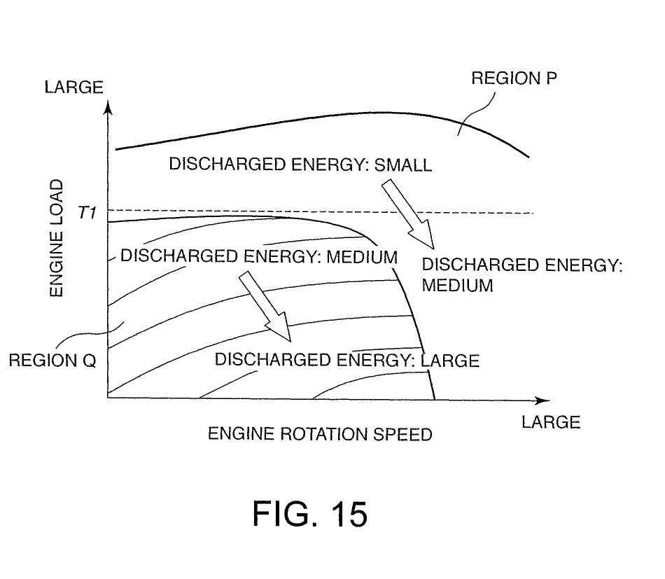

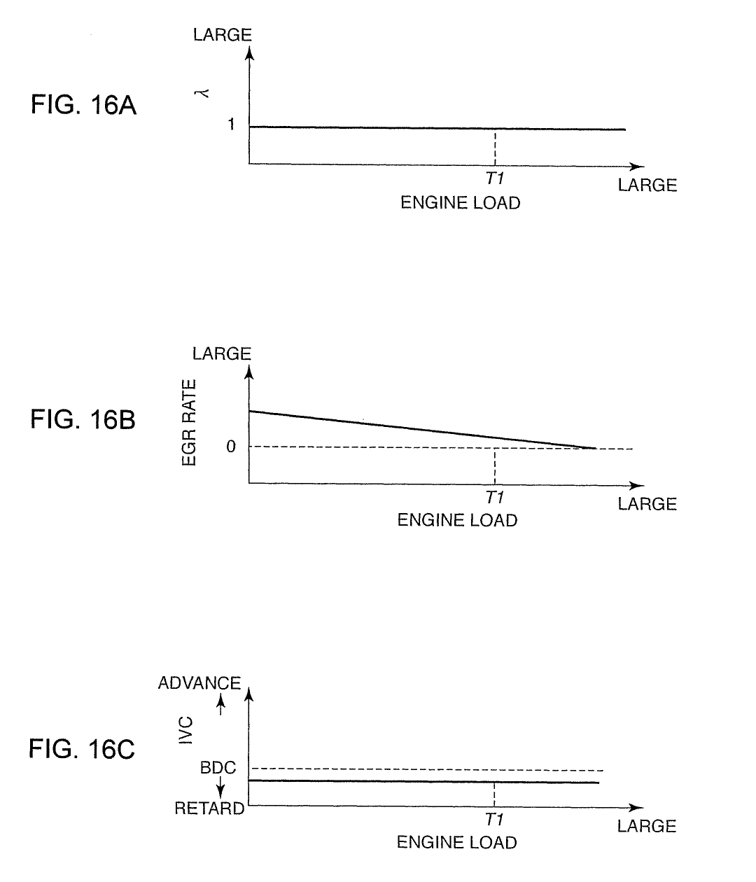

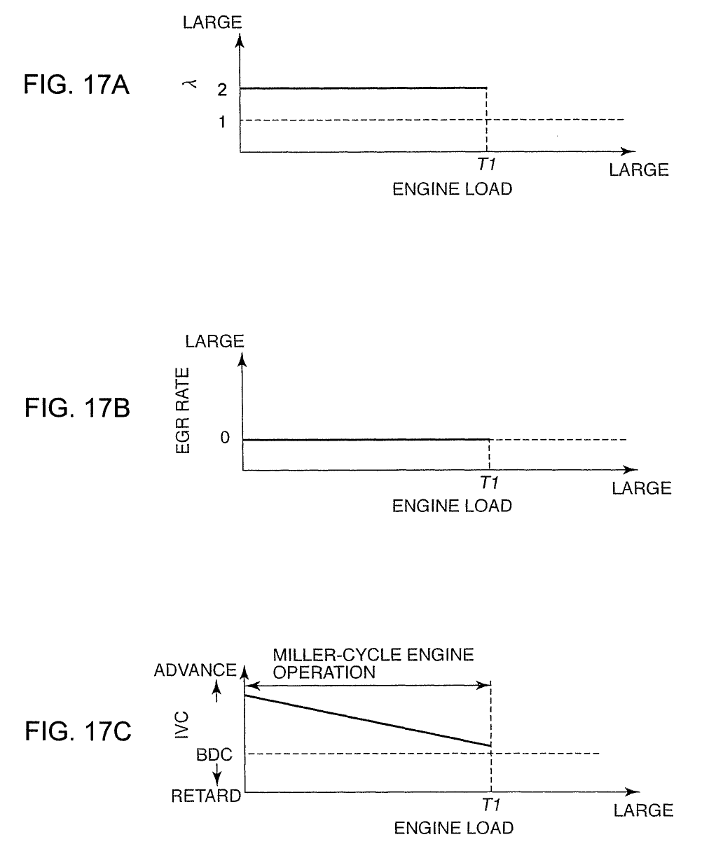

The internal combustion engine 100 equipped with the spark plug 50 described above is operated based on the operation maps of which the contents are shown in FIG. 15, FIGS. 16A-16C, and FIGS. 17A-17C.

Referring to FIG. 15, the operation range of the internal combustion engine 100 can be divided into the region P where high-rotation-speed/high-load operation is conducted and the region Q where low-rotation-speed/low-operation is conducted.

Referring to FIG. 16A, in the region P, the fuel injection amount of the internal combustion engine 100 is controlled such that the air excess factor λ is equal to 1, or in other words the air-fuel ratio is equal to the stoichiometric air-fuel ratio, irrespective of the engine operation state.

Referring to FIG. 16B, in the region P, the EGR rate is controlled according to the engine load, and the internal combustion engine 100 performs diluted combustion. The EGR rate in the region P is set so as to decrease as the load increases.

In the region P, the internal combustion engine 100 performs no Miller-cycle engine operation. Thus, as shown in FIG. 16C, the IVC timing for the intake valve 31 is set so as to be retarded from the piston bottom dead center.

When diluted combustion with EGR is effected in the region P, the ignition performance for the fuel mixture deteriorates. As shown in FIG. 15, in the region P, as the engine load decreases or the engine rotation speed increases, the controller 70 adjusts the voltage value, etc. of the impressed alternating current so as to increase the discharged energy in the non-equilibrium plasma discharge of the spark plug 50, thereby stabilizing the ignition performance. However, the discharged energy of the non-equilibrium plasma discharge in the region P is set smaller than that in the region Q, where low-rotation-speed/low-load operation is conducted.

Referring to FIG. 17A, in the region Q, the fuel injection amount of the internal combustion engine 100 is controlled such that the excess air factor λ is equal to 2, and the internal combustion engine 100 performs lean burn.

Referring to FIG. 17C, in the region Q, the internal combustion engine 100 performs Miller-cycle engine operation. In Miller-cycle engine operation, the advancement amount of the IVC timing is controlled to be advanced as the engine load decreases, thereby stopping the intake of fuel mixture during the intake stroke.

In the region Q, the internal combustion engine 100 performs lean burn and Miller-cycle engine operation, and performs no diluted combustion. As shown in FIG. 17B, the EGR rate is set to zero.

When, in the region Q, the internal combustion engine 100 conducts Miller-cycle engine operation while performing lean burn, the ignition performance for the fuel mixture deteriorates as compared with that in the region P. To remedy this deterioration, the controller 70 sets the discharged energy of the non-equilibrium plasma discharge of the spark plug 50 in the region Q larger than that in the region P. Further, also in the region Q, the controller 70 controls the voltage value, etc. of the impressed alternating current such that the discharged energy of the non-equilibrium plasma discharge increases as the engine load decreases, or in other words the advancement amount of the IVC timing of the intake valve 31 increases. Further, the controller 70 controls the voltage value, etc. of the impressed alternating current such that the discharged energy of the non-equilibrium plasma discharge increases as the engine rotation speed increases. In this way, the discharged energy of the spark plug 50, which effects volumetric ignition on the fuel mixture, is increased, thereby stabilizing the ignition performance.

Further, in this embodiment, radical of high reactivity is generated in the auxiliary combustion chamber 55 prior to the volumetric ignition of the fuel mixture by the spark plug 50, thereby achieving a further improvement in terms of ignition performance in the region Q.

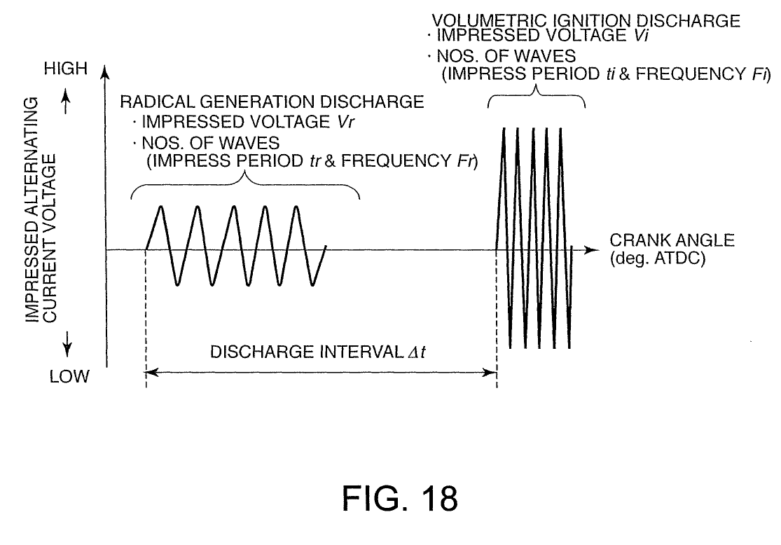

Referring to FIG. 18, the radical generated in the auxiliary combustion chamber 55 will be described.

Referring to FIG. 18, prior to volumetric ignition discharge, the spark plug 50 executes radical generation discharge to generate radical within the auxiliary combustion chamber 55. The radical generated is a chemical species of high reactivity, which promotes the combustion in the auxiliary combustion chamber 55 at the time of volumetric ignition. The radical generation amount increases as the discharged energy amount in the radical generation increases. However, when the discharged energy is excessively large, volumetric ignition occurs earlier than expected. The controller 70 therefore controls the voltage value, the impression time period, and the frequency of the impressed alternating current of the spark plug 50 such that the discharged energy of the radical generation discharge is smaller than the discharged energy at the time of volumetric ignition. As shown in FIG. 18, in radical generation discharge, it is desirable to effect control so as to decrease the voltage value, to increase the impression time period, and to decrease the frequency of the impressed alternating current of the spark plug 50 as compared with those in volumetric ignition discharge.

In the ignition device of the internal combustion engine 100 according to the third embodiment, it is possible to achieve the following effects.

In the spark plug 50, the center electrode 51 is arranged inside the insulating member 53 formed of a dielectric material. The spark plug 50 forms a number of streamers 57 between the insulating member 53 and the cylindrical electrode 52 through the non-equilibrium plasma discharge, and effects volumetric ignition on the fuel mixture in the auxiliary combustion chamber 55. Thus, even under a condition likely to lead to unstable combustion, such as lean burn or diluted combustion, it is possible to achieve a sufficiently large heat generation. As a result, it is possible to obtain the same effect as that of the first embodiment.

The spark plug 50 of the internal combustion engine 100 executes radical generation discharge prior to volumetric ignition on the fuel mixture so as to generate radical in the auxiliary combustion chamber 55. As a result, the ignition performance with respect to the fuel mixture in the auxiliary combustion chamber 55 increases, and the combustion period for the fuel mixture can be shortened, making it possible to obtain the same effect as that of the second embodiment.

In the spark plug 50, the center electrode 51 is covered with the insulating member 53, and hence, even when the discharged energy increases, it is possible to suppress transition from the non-equilibrium plasma discharge to equilibrium plasma discharge. By using the non-equilibrium plasma discharge, it is possible to ignite the fuel mixture with low energy consumption.

The voltage value, the impression time period, the frequency, etc. of the impressed alternating current is controlled such that the discharged energy of the radical generation discharge is smaller than that of the volumetric ignition discharge, and hence it is possible to suppress premature volumetric ignition through radical generation discharge.

The contents of JP2007-201960, with a filing data of Aug. 2, 2007 in Japan, are hereby incorporated by reference.

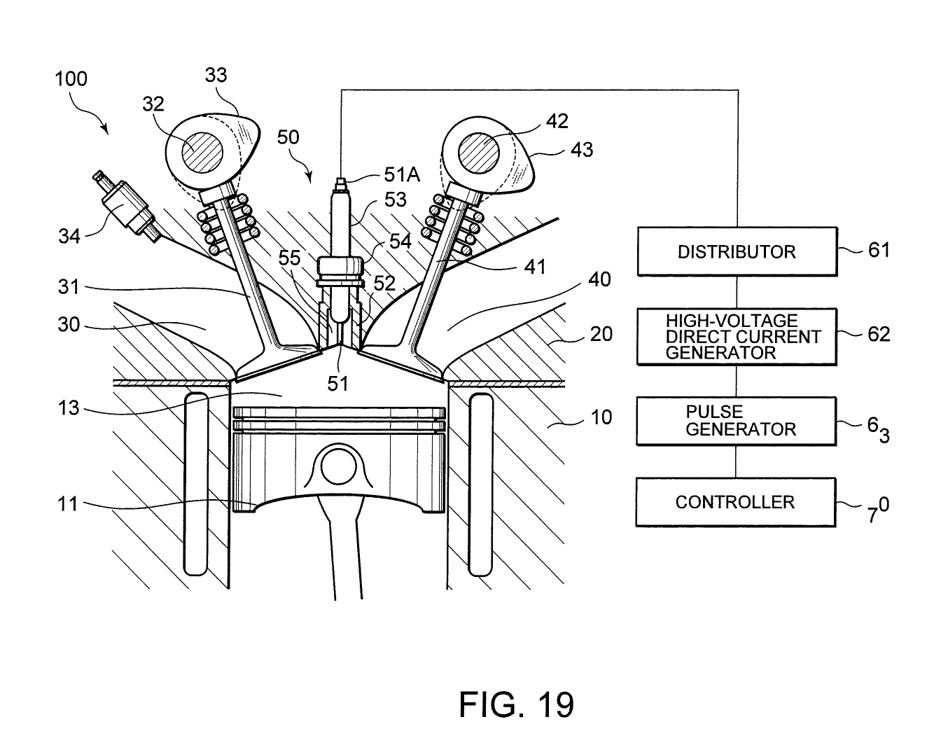

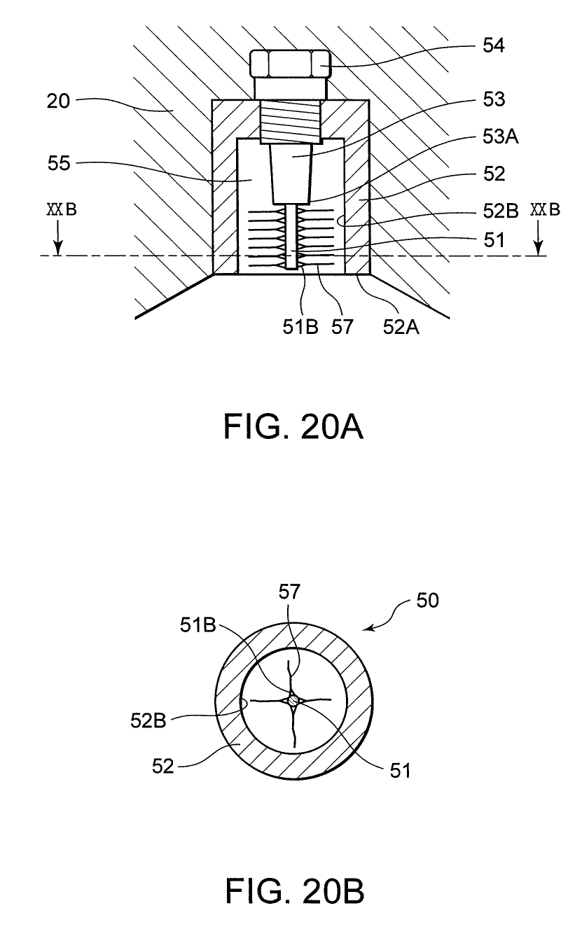

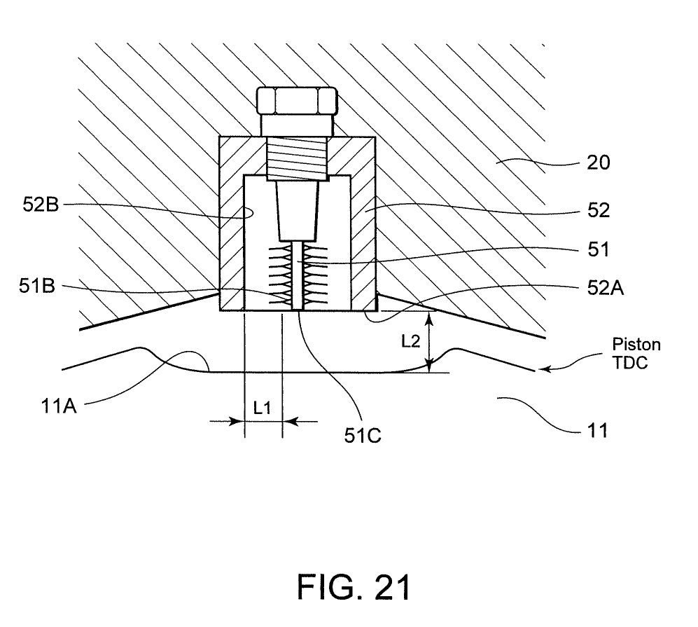

Referring to FIG. 19, FIGS. 20A and 20B, and FIG. 21, a fourth embodiment of this invention will be described.

Referring to FIG. 19, in the internal combustion engine 100, a pent roof type combustion chamber 13 is formed by a crown surface of the piston 11, a wall surface of the cylinder 12, and a bottom surface of the cylinder head 20. An intake port 30 for supplying fuel mixture to the main combustion chamber 13 and an exhaust port 40 for expelling exhaust gas from the main combustion chamber 13 are formed in the cylinder head 20.

The intake valve 31 is provided at an opening end of the intake port 30 which leads to the combustion chamber 13. The intake valve 31 is opened and closed with a predetermined timing by the cam 33 in contact with the valve stem end. The cam 33 is integral with an intake cam shaft 32, and the intake cam shaft 32 is driven by a crankshaft in synchronism with the movement of the piston 11.

The exhaust valve 41 is provided at the opening end of the exhaust port 40 which leads to the combustion chamber 13. The exhaust valve 41 is opened and closed with a predetermined timing by the cam 43 in contact with the valve stem end. The cam 43 is integral with an exhaust cam shaft 42, and the exhaust cam shaft 42 is driven by the crankshaft in synchronism with the movement of the piston 11.

While in the internal combustion engine 100 of this embodiment two intake valves 31 and two exhaust valves 41, i.e., four valves in total, are provided for one cylinder, there are no limitations regarding the number of the intake valves 31 and the exhaust valves 41.

The fuel injector 34 is installed in the intake port 30. The fuel injector 34 injects fuel toward the opening end of the intake port 30.

When the piston 11 moves downwards, the pressure in the combustion chamber 13 becomes lower than the pressure in the intake port 30. When the intake valve 31 is opened in this state, fuel mixture flows from the intake port 30 into the combustion chamber 13 together with the atomized fuel due to the difference in pressure between the intake port 30 and the combustion chamber 13. At this time, due to the gas flow generated in the combustion chamber 13, the vaporization of the atomized fuel is promoted, and fuel mixture is formed. After the intake valve 31 is closed, the fuel mixture is compressed through ascent of the piston 11, and an appropriate amount of heat energy is imparted to the fuel mixture. Before the piston 11 has reached the compression top dead center, the fuel mixture is ignited through the non-equilibrium plasma discharge of the spark plug 50.

The spark plug 50 is equipped with the center electrode 51, the cylindrical electrode 52, the insulating member 53, and the outer shell 54.

The spark plug 50 is accommodated in a recess formed in the cylinder head 20, and is fixed to the cylinder head 20 via the outer shell 54 provided at the center in the axial direction.

Referring to FIGS. 20A and 20B, the cylindrical electrode 52 formed as a bottomed cylinder is provided to cover the forward end 53A of the insulating member 53 and the bar-like center electrode 51 protruding downwards from the forward end 53A. The center electrode 51 and the cylindrical electrode 52 are formed of a conductive material. The cylindrical electrode 52 is connected to the ground via the cylinder head 20.

The ignition chamber 55 in the form of an annular gap is formed between the cylindrical electrode 52 and the center electrode 51. The cylindrical electrode 52 has an opening end 55A so that the ignition chamber 55 communicates with the combustion chamber 13.

The center electrode 51 protruding substantially at the center of the cylindrical electrode 52 is provided with seven projections 51B in the form of radial projections provided at predetermined axial intervals. The projections 51B provided around the center electrode 51 are provided not only in the axial direction but also in the circumferential direction of the center electrode 51 at four positions at equal intervals. While in FIGS. 20A and 20B the projections 51B are provided at seven axial positions and at four circumferential positions of the center electrode 51, i.e., the center electrode 51 has twenty-eight projections 51B in total, but the number of projections 51B is not restricted to this.

By providing the center electrode 51 with a number of projections 51B, the electric field intensity in the ignition chamber 55 is not uniform at the time of high voltage impression to the center electrode 51, and the electric field intensity is enhanced at the positions of the projections 51B. Then, in the portion where the distance between the center electrode 51 and the inner peripheral wall 52B of the cylindrical electrode 52 is small, in other words between the projections 51B and the inner peripheral wall 52B, so-called streamers 57 i.e., a transitional non-equilibrium plasma discharge preceding equilibrium plasma discharge are generated.

The streamers 57 are generated within the ignition chamber 55 in correspondence with the projections 51B. By forming a number of the streamers 57, the spark plug 50 increases the electron temperature of the ignition chamber 55 to enhance the molecular activity thereof. As a result, there is realized simultaneous ignition at a number of points in the ignition chamber 55. This type of ignition will be referred to as volumetric ignition. When volumetric ignition is thus effected on the fuel mixture, the combustion gas in the ignition chamber 55 is ejected into the combustion chamber 13 situated below the ignition chamber 55, and combustion with respect to the fuel mixture in the combustion chamber 13 is started from a position near the opening end 52A.

The projections 51B serve to generate the streamers 57 in the non-equilibrium plasma discharge. It is also possible to provide a number of projections 51B in the axial direction and in the inner peripheral direction of the cylindrical electrode 52 so as to protrude from the inner wall surface 52B toward the center electrode 51.

It is also possible to provide the projections at a number of positions in the axial direction and in the peripheral direction of the center electrode 51, and to provide the projections at positions on the inner wall surface 52B of the cylindrical electrode 52 opposed to the projections.

It is also possible to provide recesses at a number of positions in the axial direction and in the peripheral direction of the center electrode 51, and to provide the same number of recesses at positions on the inner wall surface 52B of the cylindrical electrode 52 opposed to those recesses of the center electrode 51 in order to provide a number of pairs of projections.

As described above, in the spark plug 50, projections or recesses are provided so that streamers 57 of the non-equilibrium plasma discharge may be generated at a number of positions of the center electrode 51 so as to extend toward the inner wall surface 52B of the cylindrical electrode 52.

A terminal 51A is mounted to the upper end of the center electrode 51. As shown in FIG. 19, a distributor 61, a high-voltage direct current generator 62, and a pulse generator 63 are successively connected to the terminal 51A.

When high voltage is impressed between the center electrode 51 and the cylindrical electrode 52 for a long period of time, and the streamers 57 grow to an excessive degree, transition to equilibrium plasma discharge is effected. When the discharge mode is changed to equilibrium plasma discharge, a large quantity of electric current flows through a portion bridged by the equilibrium plasma discharge, and hence the power consumption increases. On the other hand, when the impressed voltage between the center electrode 51 and the cylindrical electrode 52 is low, the generated amount of streamers 57 is small or a dark current state is attained in which streamers 57 themselves are not generated, resulting deterioration in ignition performance.

To satisfy a condition for effecting the non-equilibrium plasma discharge in which streamers 57 are generated at a plurality of positions of the center electrode 51, it is necessary to impress high voltage between the center electrode 51 and the cylindrical electrode 52 in a short pulse width of one micro-second or less by the high-voltage direct current generator 62 and the pulse generator 63. The pulse generator 63 is controlled by the controller 70 so as to generate a short pulse at the time of ignition.

Referring to FIG. 21, the gap L1 between the projections 51B of the center electrode 51 and the inner wall surface 52B of the cylindrical electrode 52 is set so as to be smaller than the vertical distance L2 between the crown surface 11A of the piston 11 at the compression top dead center position substantially close to the ignition timing and the forward end 51C of the center electrode 51. If the vertical distance L2 is set smaller than the gap L1, equilibrium plasma discharge is allowed to occur between the center electrode 51 and the piston 11 before the streamers 57 have been generated between the center electrode 51 and the cylindrical electrode 52, with the result that no volumetric ignition is effected on the fuel mixture in the ignition chamber 55. To avoid this, the gap L1 is set smaller than the vertical distance L2.

As a result, it is possible to always generate the same electric field within the ignition chamber 55, making it always possible to generate streamers 57 at a number of positions within the ignition chamber 55 independently of the ignition timing.

As shown in FIG. 21, the piston 11 has a cavity in the crown surface 11A so as to form a tumble flow swirling longitudinally in the combustion chamber 13.

In the ignition device of the internal combustion engine 100 according to the fourth embodiment, it is possible to achieve the following effects.

In the spark plug 50, a number of projections 51B are provided in the outer periphery of the center electrode 51 so that streamers 57 of the non-equilibrium plasma discharge may be generated at a plurality of axial positions and peripheral positions of the center electrode 51. Due to the provision of the projections 51A on the center electrode 51, the electric field intensity is not uniform within the ignition chamber 55 at the time of high voltage impression to the center electrode 51, and the electric field intensity is enhanced at the positions of the projections 51B. Then, the streamers 57 extend between the projections 51B and the inner peripheral wall 52B of the cylindrical electrode 52. A plurality of streamers 57 are generated in correspondence with the projections 51B in the ignition chamber 55. By forming a number of streamers 57, the spark plug 50 increases the electron temperature of the combustion chamber 13 to thereby enhance the molecular activity thereof. As a result, it is possible to effect in the ignition chamber 55 a simultaneous ignition at a number of points, namely, volumetric ignition. When volumetric ignition is thus effected on the fuel mixture, the combustion gas in the ignition chamber 55 is injected into the combustion chamber 13 as the main combustion chamber situated below the ignition chamber 55 as the auxiliary combustion chamber, and combustion is started on the fuel mixture in the combustion chamber 13 from a position near the opening end 52A.

Thus, even under a condition likely to lead to unstable combustion, such as lean burn or diluted combustion, it is possible to achieve a sufficiently large heat generation. As a result, the ignition performance with respect to the fuel mixture in the combustion chamber 13 increases, and the combustion period for the fuel mixture can be shortened, making it possible to substantially expand the lean burn limit. Thus, unlike the prior art in which ignition is effected solely at one position through the non-equilibrium plasma discharge between a pair of electrodes, it is possible to avoid a situation in which the heat generation amount per unit volume is rather small, resulting in flame-out due to failure to effect chain heat generation in the periphery.

In the spark plug 50, the gap L1 between the projections 51B of the center electrode 51 and the inner peripheral wall 52B of the cylindrical electrode 52 is set smaller than the vertical distance L2 between the crown surface 11A of the piston 11 and the forward end 51C of the center electrode 51 at the compression top dead center. Thus, it is possible to avoid generation of equilibrium plasma discharge between the center electrode 51 and the piston 11. As a result, it is possible to effect volumetric ignition on the fuel mixture in the ignition chamber 55 independently of the piston position at the time of ignition, making it possible to set the ignition timing irrespective of the piston position.

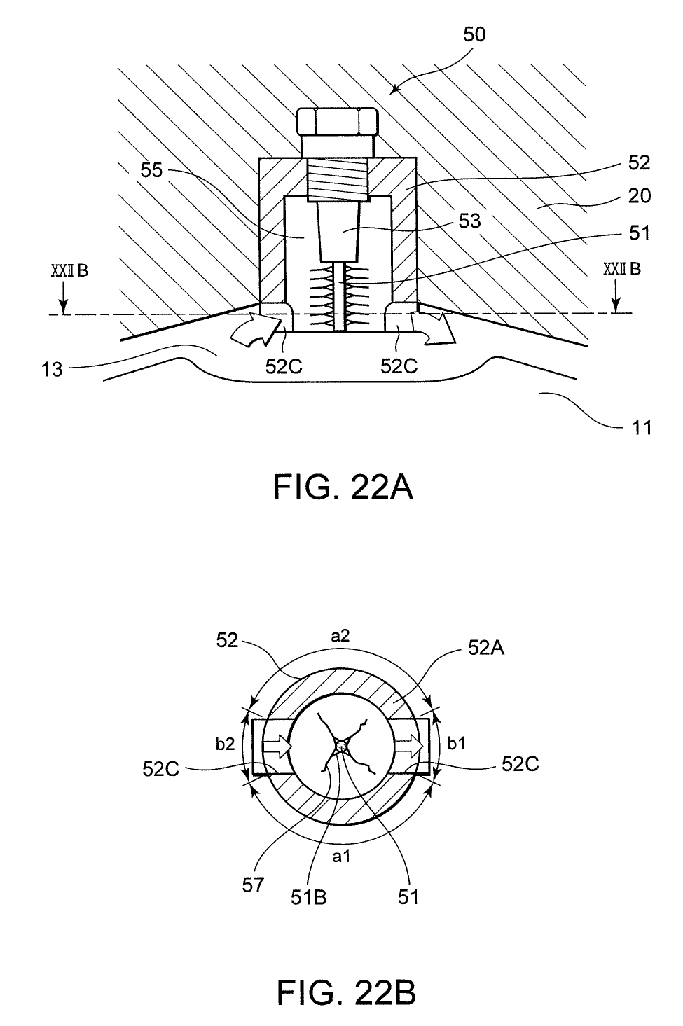

Referring to FIGS. 22A and 22B, a fifth embodiment of this invention will be described. FIG. 22A corresponds to FIG. 20A showing the fourth embodiment, and FIG. 22B corresponds to FIG. 20B showing the fourth embodiment.

The construction of the internal combustion engine 100 according to the fifth embodiment is substantially the same as that of the fourth embodiment except for the construction of the spark plug 50. In other words, cutouts 52C are formed in the cylindrical electrode 52. The following description will center on this difference.

In the internal combustion engine 100 according to the fifth embodiment, a tumble flow is generated in the combustion chamber 13. The tumble flow is a gas flow swirling around an axis orthogonal to the piston axis in the combustion chamber 13. The tumble flow is generated by enhancing the gas flow in the combustion chamber 13 by a tumble control valve provided at the intake port 30.

Referring to FIG. 22A, since the intake port 30 is on the left side in the drawing, a clockwise tumble flow is generated as indicated by the arrows.

As shown in FIG. 22A, the spark plug 50 has the cutouts 52C in conformity with the flowing direction of the tumble flow, in other words, of the lower end of the cylindrical electrode 52, the position on the left side in the drawing, which is the nearest to the intake port 30, and the position on the right side in the drawing, which is the nearest to the exhaust port 40.

Referring to FIG. 22B, in the cylindrical electrode 52, assuming that the peripheral lengths of the cutouts 52C are b1 and b2, and that the peripheral lengths of the other portions of the opening end 52A of the cylindrical electrode 52 are a1 and a2, the value of a1 plus a2 is larger than the value of b1 plus b2. While in this embodiment the cylindrical electrode 52 has two cutouts 52C, at least one cutout 52C is sufficient therefor.

In the ignition device of the internal combustion engine 100 according to the fifth embodiment, it is possible to achieve the following effects.

In the spark plug 50, the cylindrical electrode 52 has the cutouts 52C so as to extend along the flowing direction of the tumble flow, and hence it is possible to introduce the fuel mixture smoothly into the ignition chamber 55 before combustion. Thus, there is no fear of the burned gas in the ignition chamber 55 failing to be scavenged to be carried over to the next cycle. As a result, it is possible to suppress local variation of the air-fuel ratio or the EGR rate in the combustion chamber 13 and the ignition chamber 55, and deterioration in ignition performance is avoided.

In the spark plug 50, the peripheral length b1+b2 of the cutouts 52C is set smaller than the peripheral length a1+a2 of the portions of the opening end 52A other than the cutouts 52C, and hence it is possible to effect volumetric ignition in the ignition chamber 55 while allowing the burned gas in the ignition chamber 55 to escape.

In the spark plug 50, the cutouts 52 for passage of the fuel mixture are formed at the opening end 52A of the cylindrical electrode 52, and hence it is possible to suppress the opening end 52A of the cylindrical electrode 52 is heated by the combustion subsequent to the volumetric ignition, making possible to suppress pre-ignition due to heat gathered in the ignition chamber 55.

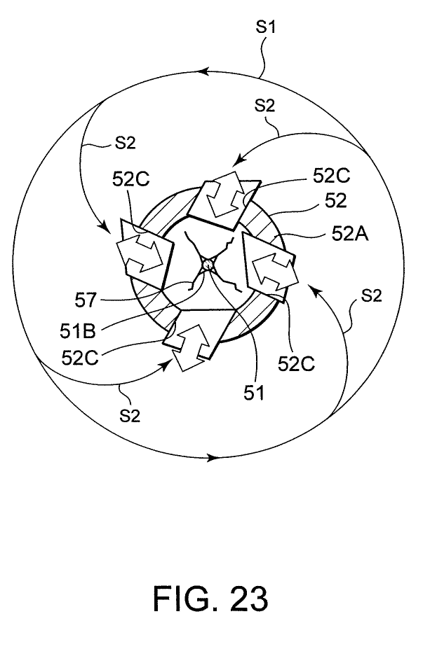

Referring to FIGS. 23, a sixth embodiment of this invention will be described. FIG. 23 corresponds to FIG. 22B showing the fifth embodiment.

The construction of the internal combustion engine 100 according to the sixth embodiment is substantially the same as that of the fourth embodiment except for the construction of the spark plug 50. In other words, cutouts 52C are formed in the cylindrical electrode 52 in the flowing direction of a swirl flow. The following description will center on this difference.

In the internal combustion engine 100 according to the sixth embodiment, the swirl flow is generated in the combustion chamber 13. The swirl flow is a gas flow swirling around the piston axis in the combustion chamber 13. The swirl flow is generated by enhancing the gas flow in the combustion chamber 13 by a swirl control valve provided in the intake port 30. It is also possible to provide the intake port 30 with a gas flow control valve controlling the gas flow so as to generate a swirl component in addition to the tumble flow in the combustion chamber 13.

Referring to FIG. 23, in the internal combustion engine 100, a counterclockwise swirl flow is generated as indicated by the arrow S1.

In the spark plug 50, four cutouts 52C are provided at equal intervals at the opening end 52A of the cylindrical electrode 52 so that the fuel mixture may flow into the ignition chamber 55 with a flow S2 branching off from the swirl flow S1. While in this embodiment four cutouts 52C are formed in the cylindrical electrode 52, at least one cutout 52C is sufficient therefor.

In the ignition device for the internal combustion engine 100 according to the sixth embodiment, it is possible to achieve the following effects.

In the spark plug 50, the cutouts 52C are provided in the cylindrical electrode 52 in the flowing direction of the swirl flow, and hence the fuel mixture introduced through the cutouts 52C reaches the upper portion of the ignition chamber 55 while swirling within the ignition chamber 55. As a result, it is possible to promote the generation of fuel mixture in the ignition chamber 55. Further, it is possible to smoothly effect the scavenging of the burned gas out of the ignition chamber 55 and the introduction of the unburned fuel mixture into the ignition chamber 55, and hence it is possible to avoid a locally excessive diluted fuel mixture concentration in the ignition chamber 55, making it possible to effect combustion in a stable manner in the ignition chamber 55.

In the spark plug 50, the cutouts 52 for passage of the fuel mixture are formed at the opening end 52A of the cylindrical electrode 52, and hence it is possible to suppress the opening end 52A of the cylindrical electrode 52 is heated by the combustion subsequent to the volumetric ignition, making possible to suppress pre-ignition due to heat gathered in the ignition chamber 55.

Although the invention has been described above with reference to certain embodiments, the invention is not limited to the embodiments described above. Modifications and variations of the embodiments described above will occur to those skilled in the art, within the scope of the claims.

For example, the first through third embodiments are applied to a four-stroke-cycle reciprocating engine, but this invention is also applicable to a two-stroke-cycle engine.

The first through third embodiments are applied to a port injection type internal combustion engine, in which the fuel injector 34 is arranged at the intake port 30, but this invention is also applicable to a in-cylinder direct injection type engine, in which fuel is directly injected into the combustion chamber.

In the first through third embodiments, the fuel mixture of the main combustion chamber 13 flows into the auxiliary combustion chamber 55 during the compression stroke, but it is also possible to directly supply gasoline or reformed fuel such as hydrogen into the auxiliary combustion chamber 55. In this case, the combustion in the auxiliary combustion chamber 55 is enhanced, and hence it is possible to increase the power of the torch ignition, making it possible to further increase the combustion speed in the main combustion chamber 13.

While, in the second and third embodiments, the IVC timing is advanced with respect to the piston bottom dead center, and the intake of fuel mixture is stopped during the intake stroke to thereby vary the intake amount of fuel mixture, it is also possible to vary the intake amount of fuel mixture by retarding the IVC timing with respect to the piston bottom dead center. When the internal combustion engine 100 performs Miller-cycle engine operation, the controller 70 controls the impressed voltage, etc. such that the discharged energy of the non-equilibrium plasma discharge becomes larger as the retarding amount of the intake valve 31 increases, thereby stabilizing the ignition performance.

In the fourth through sixth embodiments, projections 51B are provided on the center electrode 51, and the non-equilibrium plasma discharge is effected between the center electrode 51 and the cylindrical electrode 52. When the center electrode 51 is formed in a columnar configuration with no projections 51B, it is also possible to generate streamers 57 of the non-equilibrium plasma discharge at a number of positions of the center electrode 51 by controlling the voltage value, the impression time, etc. of the impressed voltage.

The embodiments of this invention in which an exclusive property or privilege are claimed are defined as follows:

1. An ignition device which performs a spark ignition of a fuel mixture in a combustion chamber of an internal combustion engine, comprising:
a first electrode;
a second electrode which is opposed to the first electrode and extends in a length allowing generation of a plurality of non-equilibrium plasma discharges; and
a voltage impressing device which impresses voltage between the first electrode and the second electrode to generate the non-equilibrium plasma discharge between the first electrode and the second electrode.

2. The ignition device as defined in claim 1, wherein the combustion chamber of the internal combustion engine has a main combustion chamber and an auxiliary combustion chamber communicating with the main combustion chamber via an injection hole, the first electrode extends into the auxiliary combustion chamber, the second electrode is arranged to be opposed to the first electrode, and the voltage impressing device impresses voltage between the first electrode and the second electrode to effect volumetric ignition on the fuel mixture in the auxiliary combustion chamber through the non-equilibrium plasma discharge between the first electrode and the second electrode.

3. The ignition device as defined in claim 2, wherein the second electrode is formed in a cylindrical shape to form the auxiliary combustion chamber on the inner side thereof, and the first electrode comprises a bar-like member disposed coaxially on an inner side of the second electrode.

4. The ignition device as defined in claim 3, wherein the voltage impressing device is configured to adjust voltage characteristics of the voltage impressed between the first electrode and the second electrode to thereby control a discharged energy of the non-equilibrium plasma discharge according to an operating condition of the internal combustion engine.

5. The ignition device as defined in claim 4, wherein the voltage impressing device is configured to control the discharged energy of the non-equilibrium plasma discharge is smaller than that at a time of ignition so as to generate radical within the auxiliary combustion chamber prior to igniting the fuel mixture in the auxiliary combustion chamber.

6. The ignition device as defined in claim 4, wherein the voltage impressing device is configured to set the discharged energy of the non-equilibrium plasma discharge to increase as an engine load decreases.

7. The ignition device as defined in claim 4, wherein the voltage impressing device is configured to set the discharged energy of the non-equilibrium plasma discharge to increase as an engine rotation speed increases.

8. The ignition device as defined in claim 4, wherein the internal combustion engine makes an air-fuel ratio of the fuel mixture in the main combustion chamber leaner as the engine load decreases, and the voltage impressing device is configured to set the discharged energy of the non-equilibrium plasma discharge to increase as the air-fuel ratio becomes leaner.

9. The ignition device as defined in claim 4, wherein the internal combustion engine increases an EGR rate as the engine load decreases, and the voltage impressing device is configured to set the discharged energy of the non-equilibrium plasma discharge to increase as the EGR rate increases.

10. The ignition device as defined in claim 4, wherein the internal combustion engine advances or retards a valve closing timing for an intake valve to be away from a timing when a piston is at a bottom dead center as the engine load decreases, and the voltage impressing device is configured to set the discharged energy of the non-equilibrium plasma discharge to increase as an advancing amount or a retarding amount of the valve closing timing increases.

11. The ignition device as defined in claim 4, wherein the voltage impressing device is configured to adjust at least one of a voltage value, a pulse width, and the number of impression of the impressed direct current, to thereby control the discharged energy of the non-equilibrium plasma discharge.

12. The ignition device as defined in claim 3, wherein a dielectric member is interposed between the first electrode and the second electrode, and the voltage impressing device impresses an alternating current between the first electrode and the second electrode to generate the non-equilibrium plasma discharge between the dielectric member and one of the first electrode and the second electrode.

13. The ignition device as defined in claim 12, wherein the voltage impressing device is configured to adjust at least one of a voltage value, a frequency, and an impression time of the impressed alternating current between the first electrode and the second electrode, to thereby control the discharged energy of the non-equilibrium plasma discharge according to an operating condition of the internal combustion engine.

14. The ignition device as defined in claim 1, wherein the second electrode is formed in a cylindrical shape to face the combustion chamber, and the first electrode is formed by a bar-like member disposed coaxially on an inner side the second electrode.

15. The ignition device as defined in claim 14, further comprising a plurality of projections protruding from one of the first electrode and the second electrode toward the other of the first electrode and the second electrode.

16. The ignition device as defined in claim 15, wherein the projections are formed on both the first electrode and the second electrode.

17. The ignition device as defined in claim 15, wherein the projections are formed to extend toward an inner peripheral wall of the second electrode from a plurality of axial positions and peripheral positions of the first electrode.

18. The ignition device as defined in claim 17, wherein the internal combustion engine comprises a piston, and wherein a gap between the projections of the first electrode and the inner peripheral wall of the second electrode is smaller than a distance between a crown surface of the piston and a forward end of the first electrode at compression top dead center.

19. The ignition device as defined in claim 14, wherein the second electrode has a cutout for allowing passage of fuel mixture at an opening end open to the combustion chamber.

20. The ignition device as defined in claim 19, wherein, of a peripheral length of the opening end of the second electrode, a peripheral length of the cutout portion is smaller than a peripheral length of the portion other than the cutout.
